(19) United States
(12) Patent Application Publication
(10) Pub. No.: US 2026/0169749 A1
(43) Pub. Date: Jun. 18, 2026

(54) DEVICE, METHOD AND SYSTEM FOR CONTROLLING MICRO-OPERATION SERIALIZATION WITH RESERVATION STATIONS

(71) Applicant: Intel Corporation, Santa Clara, CA (US)

(72) Inventors: Rafael Trapani Possignolo, Hillsboro, OR (US); Xiang Zou, Portland, OR (US); Thomas Toll, Portland, OR (US); Henry Wong, Hillsboro, OR (US); Nikhil Patil, Austin, TX (US)

(73) Assignee: Intel Corporation, Santa Clara, CA (US)

(21) Appl. No.: 18/986,352

(22) Filed: Dec. 18, 2024

(51) Int. Cl. G06F 9/38; G06F 9/50

(52) U.S. Cl. CPC G06F 9/3836; G06F 9/5027

(57) ABSTRACT

Techniques and mechanisms for enforcing a serialization control point (“control point”) at a reservation station (RS) of a processor. In an embodiment, a registry of control points is accessible by circuitry which allocates instructions each to a respective RS. One such RS includes a queue comprising entries which each correspond to a different respective instruction which the RS is to schedule for execution. The entries each indicate a location of the corresponding instruction in a program sequence. The RS receives an indication of a currently enforced control point, wherein the indication is generated based on the registry and a point of execution of the program sequence. Based on the indication, the RS designates a relatively old instruction as being qualified to be released for execution. In another embodiment, multiple RSs schedule respective instructions each based on the same indication of a currently enforced control point.

### BACKGROUND

### 1. Technical Field

This disclosure generally relates to processor operations and more particularly, but not exclusively, to the enforcement of a serialization control point.

### 2. Background Art

Multithreaded software, and other software executed in environments where multiple entities may potentially access the same shared memory, typically includes one or more types of memory access synchronization instructions. Various such instructions are known in the arts. Examples include memory access fence or barrier instructions, lock instructions, conditional memory access instructions, and the like. These memory access synchronization instructions are generally needed in order to help ensure that accesses to the shared memory occur in the appropriate order (e.g., occur consistently with the original program order) and thereby help to prevent erroneous results.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system 100 to implement serialization functionality at a reservation station according to an embodiment.

FIG. 2 shows a flow diagram illustrating features of a method to enforce a control point of a serialization instruction according to an embodiment.

FIG. 3 shows a block diagram illustrating features of a processor 300 to communicate serialization information with a reservation station according to an embodiment.

FIG. 4 shows a block diagram illustrating features of a processor 400 to enforce a serialization control point at each of multiple clusters according to an embodiment.

FIG. 5A shows a flow diagram illustrating features of a method to identify a most recently expired serialization control point according to an embodiment.

FIG. 5B shows a flow diagram illustrating features of a method to identify executable microoperations at a reservation station according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for enforcing a serialization control point at a reservation station of a processor. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

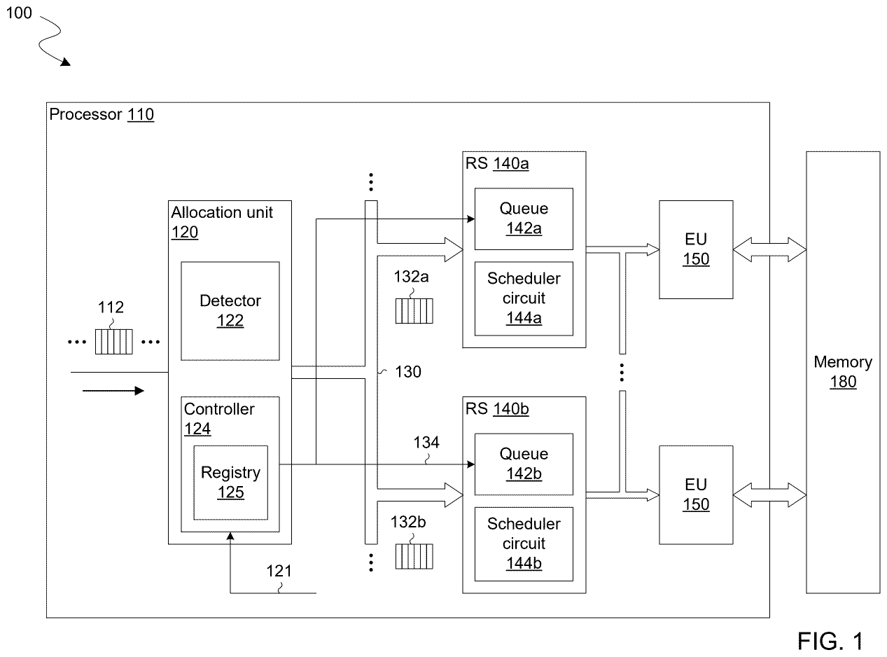

FIG. 1 shows a system 100 for implementing serialization functionality at a reservation station according to an embodiment. System 100 illustrates features of one example embodiment wherein a serialization control point is enforced at one or more reservation stations of a processor.

As used herein, “instruction” is understood to include any of various types of instructions (sometimes referred to as “macro-instructions”) which are subject to being decoded, or—alternatively—any of various types of instructions which are able to be executed based on such decoding. For example, some embodiments variously control a serialized execution of micro-operations (uops), of micro-instructions (e.g., each including a respective plurality of uops), or of ISA-level instructions. Although some example embodiments described herein include details which are specific to the execution of uops, other embodiments are not limited to such details.

As used herein in the context of serialized program execution, “execution point” refers to a location in a program sequence (i.e., in a sequence of instructions as ordered in a software program), where the location corresponds to a given instruction, the execution of which—actual or expected—has been detected. For example, a given execution point corresponds to an instruction (e.g., a most recently identified one of multiple sequentially identified instructions) which has been identified as having been executed or, for example, as being a next instruction to be executed. Notwithstanding a program sequence, various instructions are subject to being executed in a different order, relative to each other, by an out-of-order execution engine.

Some embodiments variously detect an expiration of a serialization control point based on a relative age of the control point with respect to a detected execution point in a sequence of instructions. In this particular context, “age” refers herein to a location in a sequence of instructions—e.g., wherein a relative age of a serialization control point, with respect to a given execution point, is based on the respective locations of said points in such a sequence of instructions. In some embodiments, an execution point is “detected” at least insofar as it has been identified as corresponding to a respective commit point—i.e., a point at which the effects of the executed instruction are committed and no longer speculative. For example, such a commit point includes or otherwise corresponds to an instruction retirement, or other suitable event, wherein some piece of processor state is written.

As shown in FIG. 1, system 100 comprises a processor 110 and a memory 180 coupled thereto. Processor 110 is adapted, for example, from any of various suitable single-core or multi-core processors which provide clustered processing resources. In the example embodiment shown, processor 110 comprises—e.g., at a single core thereof—an allocation unit 120, execution units (EUs) 150, and reservation stations (RSs) 140 which are configured to variously schedule the execution of instructions (e.g., uops) each by a respective one of EUs 150.

Allocation unit 120 is configured to receive a sequence 112 of instructions that, for example, are generated by a front-end (not shown) of processor 110. In one such embodiment, the front-end fetches and decodes software instructions to generate instructions (e.g., uops) of sequence 112. Some embodiments are not limited with respect to how sequence 112 is provided to allocation unit 120.

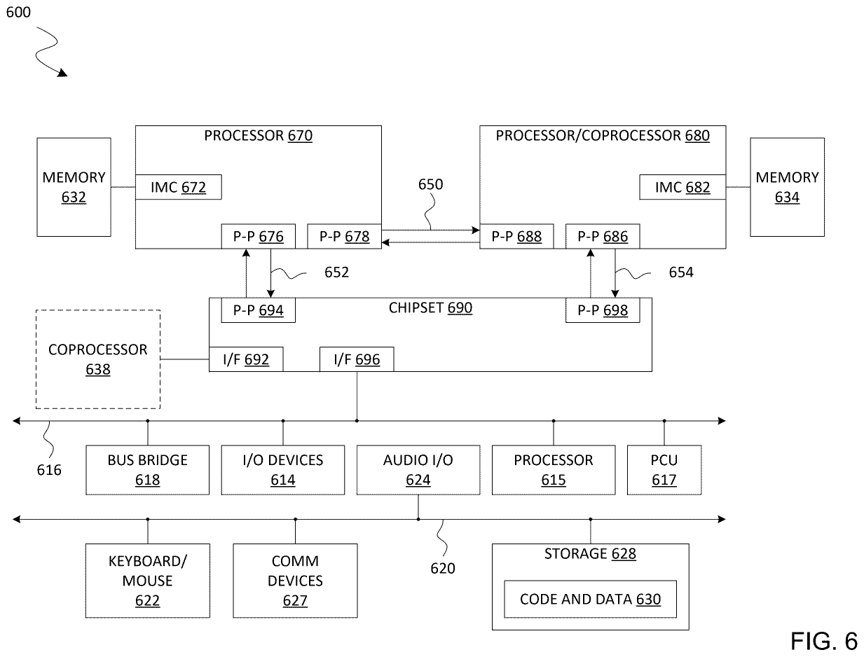

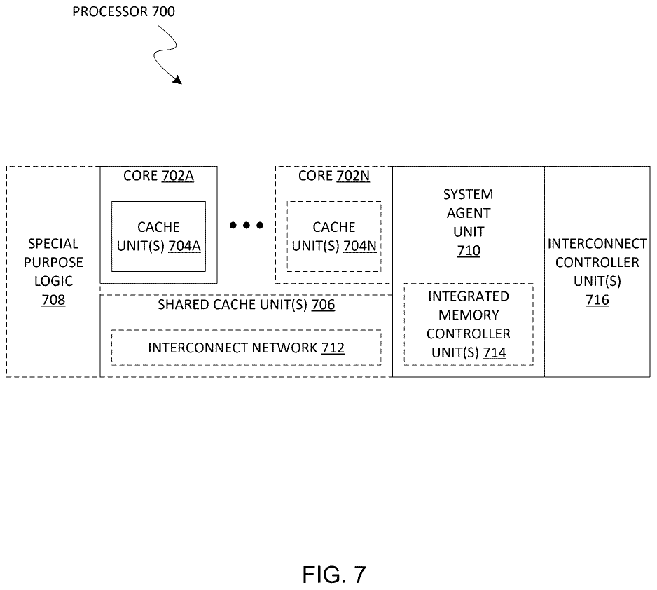

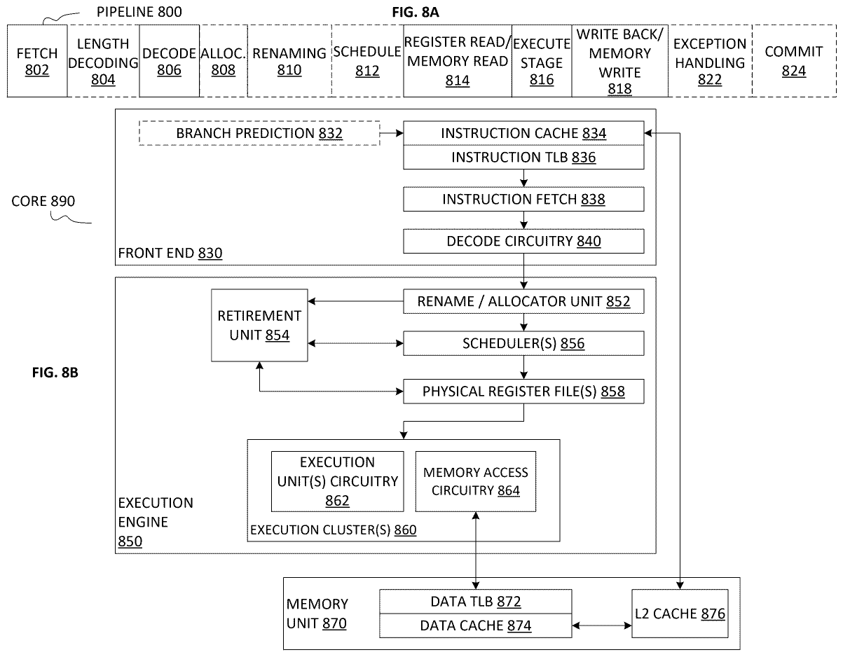

In some embodiments, circuitry of processor 110 is adapted from, and/or is incorporated with, any of various suitable processor architectures. By way of illustration and not limitation, any of various suitable embodiments of processor 110 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In an embodiment, allocation unit 120 is coupled, via one or more interconnect structures (e.g., including the illustrative network 130 shown), to variously provide instructions of sequence 112 each to a respective one of RSs 140. In an illustrative scenario according to one embodiment, a reservation station (RS) queue 142a receives a strand of consecutive instructions 132a in the instruction sequence 112, wherein another RS queue 142b receives a different strand of consecutive instructions 132b in instruction sequence 112.

Some embodiments variously facilitate efficient serialization of software execution by enforcing a serialization control point at a location which, as compared to existing processor architectures, is more tightly coupled to the operation of scheduler circuitry. In enforcing a control point more closely to a scheduler, some embodiment variously provide relatively time efficient releasing of instructions which are determined to be qualified for execution.

By way of illustration and not limitation, allocation unit 120 comprises a detector 122 which includes circuitry to identify a serialization control point based on instruction sequence 112. For example, detector 122 is coupled to snoop or otherwise detect—e.g., based on an opcode of a given instruction of sequence 112—that the instruction is of a serialization control instruction type, is based on a decoding of a serialization (macro)instruction, and/or the like. In an embodiment, detector 122 identifies an instruction as being based on any of various suitable serialization instructions (such as a LFENCE instruction, a SFENCE instruction, or a MFENCE instruction) of an x86 instruction set, any of various suitable serialization instructions (such as a DMB instruction, a DSB instruction, or an ISB instruction) of an ARM instruction set, or the like.

Serialization control points—or, for brevity, simply “control points” herein—are subject to being enforced, in succession with each other, according to their respective ages (e.g., based on the ages of the respective serialization instructions on which the control points are variously based). In this particular context, “age” refers to the location of a given instruction (or control point) in a program sequence such as sequence 112—e.g., the location relative to a different location of another instruction (or control point) in said program sequence. For example, where a first instruction is followed by a second instruction in a program sequence, the first instruction is understood to be relatively “old” in age, as compared to the second instruction, and the second instruction is understood to be relatively “young” in age. Similarly, where a first control point is earlier in a program sequence than a second control point, the first control point is understood to “older” than the second control point, whereas, the second control point is understood to be the “younger” control point.

In the context of a given control point, “expired”, “expiration” and related terms variously refer herein to the characteristic of a control point being older than a detected (e.g., most recently detected) point of execution of the program sequence in question (such as sequence 112). Before any such expiration, a given control point is the “current” control point where it is currently being used as a basis for determining whether one or more instructions of the sequence in question are qualified to be released for execution. For example, enforcement of a current control point comprises at least temporarily delaying the release of one or more instructions for execution, wherein the delaying is based on the one or more instructions each being younger than the current control point. In an embodiment, a given control point is current where any other not-yet-expired control point is younger than said given control point. Such a not-yet-expired control point, which is younger than a current control point, is referred to herein as a “pending” control point—e.g., wherein a given one such pending control point awaits being designated the next current control point.

In an embodiment, allocation unit 120 includes, is coupled to access, or otherwise operates based on, a controller 124 which facilitates the enforcement of one or more serialization control points at some or all of RSs 140. For example, controller 124 includes or otherwise operates based on (and in some embodiments, maintains) a registry 125 of pending serialization control points. In one such embodiment, detector 122 accesses registry 125 (or signals controller 124 to access registry 125), based on the identification of a serialization control point, to register information which facilitates enforcement of the serialization control point.

In an embodiment, controller 124 is further coupled to receive one or more signals (such as the illustrative signal 121 shown) which specifies or otherwise indicates a detected (e.g., a most recently detected) point of execution of sequence 112 with some or all of EUs 150. Based on information in registry 125, and further based on signal 121, controller 124 detects an expiration of a registered serialization control point. In one such embodiment, controller 124 generates a signal 134 which identifies one or more control points as having expired. Alternatively or in addition, signal 134 specifies or otherwise indicates to RSs 140 some or all of the control points (e.g., including pending control points) which are registered at registry 125.

In an illustrative scenario according to one embodiment, RS 140a is coupled to receive a first instruction of sequence 112—e.g., wherein the strand of instructions 132a provided via a network 130 comprises the first instruction. In an embodiment, RS 140a comprises a queue 142a at which RS 140a enqueues first serialization information corresponding to the first instruction. For example, an entry of queue 142a receives an identifier of a first age of the first instruction (e.g., wherein the identifier is based on an instruction pointer value, or other suitable information, which corresponds to the first instruction). In some embodiments, queue 142a enqueues identifiers of the respective ages of multiple instructions (e.g., including each of instructions 132a) which are provided to RS 140a.

In an embodiment, RS 140a comprises a scheduler circuit 144a which is coupled to queue 142a. Scheduler circuit 144a provides functionality to schedule an execution of the first instruction with one or more of EUs 150. For example, RS 140a is further coupled to receive from controller 124 an indication of the expiration of a serialization control point (e.g., wherein the indication is communicated via signal 134). For example, signal 134 identifies another control point as being newly designated as the current control point. Based on the indication of an expired control point, and further based on the first serialization information in queue 142a, scheduler circuit 144a signals that the first instruction is qualified to be released for execution with one of EUs 150. For example, scheduler circuit 144a signals that the first instruction is can be released to a particular execution port.

Alternatively or in addition, another RS 140b of processor 110 is coupled to receive a second instruction of sequence 112—e.g., wherein a strand of instructions 132b provided by allocation unit 120 via network 130 comprises the second instruction. RS 140b is further coupled to receive from controller 124 the signal 134 or, alternatively, other suitable indication of a control point expiration which, for example, is also communicated to RS 140a.

In an embodiment, RS 140b similarly comprises a queue 142b at which RS 140b enqueues second serialization information corresponding to the second instruction. For example, an entry of queue 142b receives an identifier of a second age of the second instruction (e.g., based on an instruction pointer value which corresponds to the second instruction). In some embodiments, queue 142b enqueues identifiers of the respective ages of multiple instructions (e.g., including each of instructions 132b) which are provided to RS 140b.

In an embodiment, RS 140b comprises a scheduler circuit 144b which is coupled to queue 142b. Scheduler circuit 144b provides functionality to schedule an execution of the second instruction with one or more of EUs 150. For example, RS 140b is further coupled to receive from controller 124 an indication of the expiration of a serialization control point (e.g., wherein the indication is communicated via signal 134). For example, signal 134 identifies another control point as being newly designated as the current control point. Based on the indication of an expired control point, and further based on the second serialization information in queue 142b, scheduler circuit 144b signals that the second instruction is qualified to be released for execution with one of EUs 150. For example, scheduler circuit 144b signals that the second instruction is can be released to a particular execution port.

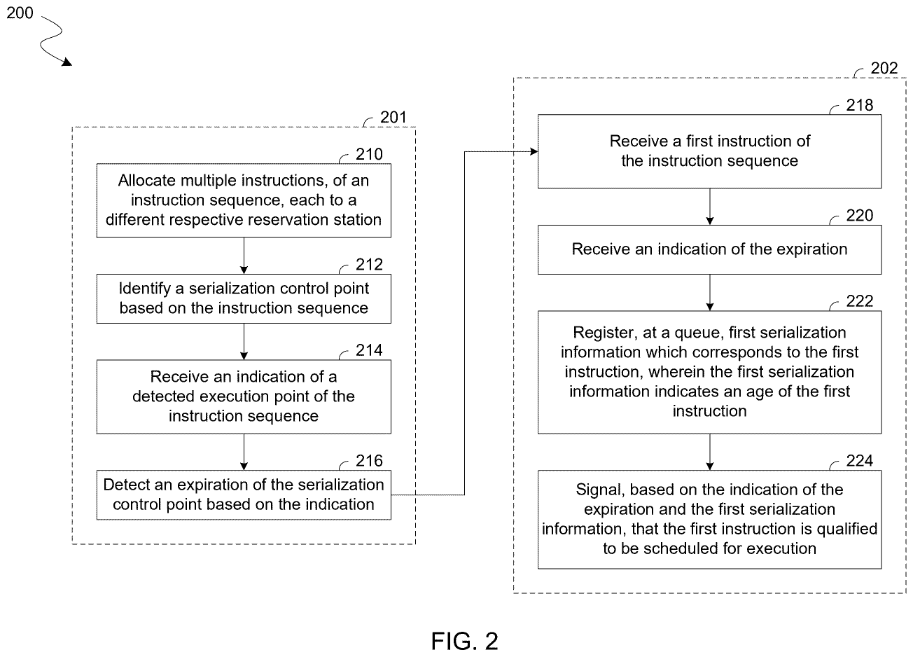

FIG. 2 shows a method 200 for enforcing a control point of a serialization instruction according to an embodiment. Method 200 illustrates one example of an embodiment wherein a reservation station receives an identifier of a serialization control point, and—based on the identifier—selectively designates one or more instructions (e.g., uops) as being qualified to be released for execution. Operations such as those of method 200 are performed with any of various combinations of suitable hardware (e.g., circuitry), firmware and/or executing software which, for example, provide some or all of the functionality of processor 110.

In some embodiments, method 200 comprises operations 201 which variously provide instructions (e.g., uops) to respective reservation stations of a processor, and which detect the expiration of a control point which is to facilitate a serialization of some or all such instructions. For example, operations 201 are performed with circuitry that provides some or all of the functionality of detector 122 and controller 124. As shown in FIG. 2, operations 201 comprise (at 210) allocating multiple instructions, of an instruction sequence, each to a different respective one of multiple reservation stations of a processor with which operations 201 are performed. Operations 201 further comprise (at 212) identifying a serialization control point based on the sequence of instructions. For example, the identifying at 212 comprises detecting that a given instruction is based on the decoding of a serialization (macro)instruction, includes a serialization opcode, and/or the like. Based on such detecting, an operand of the given instruction is identified as specifying or otherwise indicating the serialization control point, in some embodiments.

Operations 201 further comprise (at 214) receiving an indication of a detected execution point (e.g., a youngest execution point detected to-date) of the sequence, and based on the execution point indicated, detecting an expiration of the serialization control point (at 216). By way of illustration and not limitation, operations 201 further comprise—or are otherwise based on—the maintaining of a queue (or other suitable registry) of serialization control points which have yet to be identified as expired. In one such embodiment, the expiration is detected generated based on an accessing of the queue/repository, wherein said accessing is based on the indication of the detected execution point.

In an illustrative scenario according to one embodiment, the serialization control point is one of multiple serialization control points identified based on the sequence of instructions—e.g., wherein some or all of the multiple serialization control points are concurrently pending (that is, not yet expired) at a particular time. In one example embodiment, operations 201 detect an expiration of one such control point by determining that said control point now precedes a most recently detected execution point in the instruction sequence. For example, operations 201 determine that, of multiple control points which to-date had each been considered pending, one such control point is now a closest serialization control point prior to (that is, older than) a most recently detected execution point—i.e., wherein some other one of the multiple control points is now the closest serialization control point after (younger than) the detected execution point.

Additionally or alternatively, method 200 comprises operations 202—performed at one of multiple reservation stations of the processor—to locally enforce a serialization control point against the execution of one or more instructions. As shown in FIG. 2, operations 202 comprise (at 218) receiving a first instruction of an instruction sequence—e.g., wherein the first instruction is one of those allocated at 210.

Operations 202 further comprise (at 220) receiving—e.g., from the circuitry which performs operations 201—an indication of a control point expiration, such as the one which is detected at 216. In various embodiments, the reservation station at which operations 202 are performed is coupled to a corresponding reorder buffer of the processor, wherein the reorder buffer provides or otherwise facilitates the tracking of a detected execution point of the instruction sequence. In one such embodiment, the reorder buffer is accessed to provide an indication (e.g., including an instruction identifier) of a detected execution point of the instruction sequence—e.g., wherein the indication is received at 214 by the circuitry which performs operations 201.

Within a queue of the reservation station, operations 202 (at 222) register first serialization information which corresponds to the first instruction. In an embodiment, the registered first serialization information specifies or otherwise indicates an age of the first instruction. In some embodiments, the first serialization information further identifies a current execution enablement state—e.g., a value which specifies whether an executability of the first instruction is currently enabled or disabled, under the constraints (if any) of the pending serialization control point(s).

Operations 202 further comprise (at 224) scheduling an execution of the first instruction based on the first serialization information. For example, the scheduling at 224 comprises signaling, based on both the indication of the control point expiration and the first serialization information, that the first instruction is qualified to be released to a respective execution port. In one example embodiment, the serialization control point is set by a serialization instruction of the instruction sequence, wherein method 200 releases the serialization control point prior to a retirement of said serialization instruction.

In some embodiments, method 200 further comprises additional operations (not shown)—similar to operations 202—which are performed at another one of the reservation stations which receive respective instructions that are allocated at 210. By way of illustration and not limitation, such additional operations facilitate multiple reservation stations each locally enforcing the same serialization control point each against a different respective one or more allocated instructions. For example, the same serialization control point is variously enforced, by a plurality of reservation stations, based on the same indication of a control point expiration (and, accordingly, based on the same indication of a detected execution point).

In various embodiments, the queue is dedicated to a first one or more instruction types, wherein a second instruction queue of the reservation station is dedicated to a second one or more instruction types other than any of the first one or more instruction types. In one such embodiment, the reservation station locally enforces a given serialization control point against instructions represented in the first queue, but not (for example) against any instruction(s) represented in the second queue. For example, one such queue is to include or otherwise indicate only vector uops, where another queue is to include or otherwise indicate only integer uops. Accordingly, some embodiments enable reservation stations each to locally enforce a serialization control point against one (and for example, only one) instruction type—e.g., wherein no serialization control point is enforced against instructions of a different instruction type. Alternatively or in addition, such embodiments enable reservation stations each to locally enforce various serialization control points each against a different respective one (and for example, only one) instruction type.

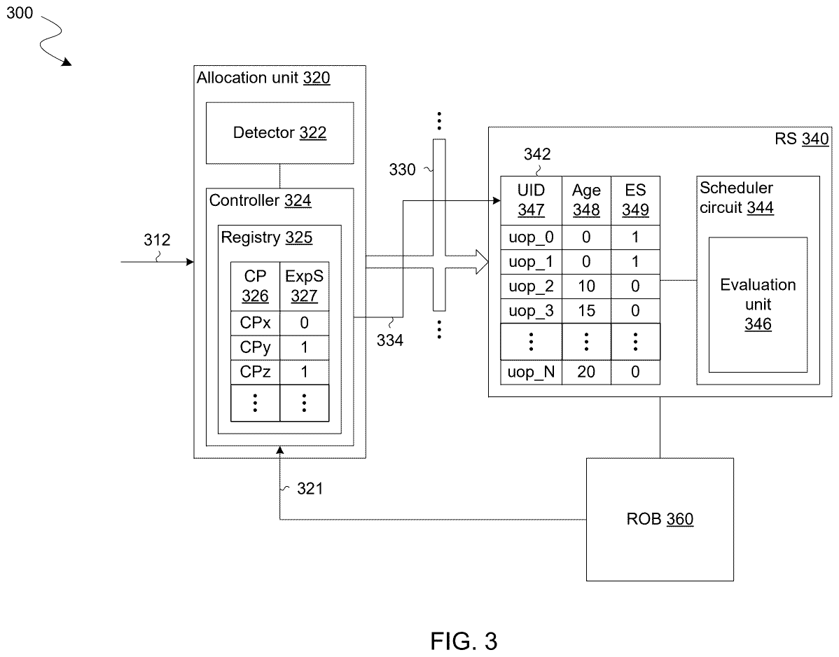

FIG. 3 shows a processor 300 that communicates serialization information with a reservation station according to an embodiment. The processor 300 illustrates features of one example embodiment in which a scheduler circuit of a processor includes, or is otherwise tightly coupled with, serialization enforcement circuitry. In some embodiments, processor 300 provides functionality such as that of processor 110—e.g., wherein operations of method 200 are performed with some or all of processor 300.

As shown in FIG. 3, processor 300 comprises an allocation unit 320 and a reservation station (RS) 340 which is coupled to allocation unit 320 via a network 330—e.g., wherein allocation unit 320, RS 340 and network 330 correspond functionally to allocation unit 120, RS 140a, and network 130 (respectively). Allocation unit 320 comprises a detector 322 and a controller 324 which, for example, provide functionality of detector 122 and controller 124 (respectively). Controller 324 includes, is coupled to access, or otherwise operates based on, a registry 325 of control point information such as that which is provided by registry 125.

In some embodiments, circuitry of processor 300 is adapted from, and/or is incorporated with, any of various suitable processor architectures. By way of illustration and not limitation, any of various suitable embodiments of processor 300 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In various embodiments, controller 324 is coupled to receive a signal 321 which changes over time to successively indicate, for each of different execution points of a sequence of micro-operations (such as the illustrative instruction sequence 312), that the execution point is the current (or at least the most recently indicated) point of execution of the sequence. In the example embodiment shown, signal 321 is provided with a reorder buffer (ROB) 360 of processor 300, and (for example) serves as a global identifier of a youngest detected execution point for sequence 312. For example, ROB 360 is coupled to receive information—e.g., from RS 340 or an execution unit (not shown) which receives instructions from RS 340—which (for example) includes or is otherwise based on an instruction pointer that corresponds to a recently executed instruction. In one such embodiment, controller 324 provides functionality to identify a current (or at least a most recently indicated) point of execution of sequence 312, and—based on said point of execution—to detect for the expiration, if any, of a registered serialization control point.

By way of illustration and not limitation, registry 325 comprises a table of entries which each correspond to a different respective serialization control point. In the example embodiment shown, a given one such entry of registry 325 comprises a respective field 326 which identifies the corresponding control point (CP)—e.g., as a particular location in the instruction sequence 312. In one such embodiment, said entry of registry 325 further comprises another respective field 327 which identifies an expiration state of the corresponding control point—e.g., wherein the respective field 327 identifies whether or not the corresponding control point has expired. Although some embodiments are not limited in this regard, entries of registry 325 are ordered based on the respective ages of the corresponding control points—e.g., according to an order of the successively younger control points CPx, CPy, CPz shown.

By way of illustration and not limitation, in a given period of time, signal 321 identifies to controller 324 an execution point of sequence 312. Based on the identified execution point, controller 324 accesses registry 325 to update and/or otherwise determine the respective expiration states of one or more serialization control points. For example, any control point which is determined to be older than the identified execution point is to be designated as expired (if not previously expired). Furthermore, the oldest not-yet-expired control point (if any) which is younger than the identified execution point is to be designated as the current control point. Where one or more such expiration states are updated based on the identification of the execution point, controller 324 communicates to RS 340 (and, for example, to one or more other RSs of processor 300)—via signal 334—that a different control point is now the current control point to be applied as a basis for determining instruction scheduling.

In an illustrative scenario according to one embodiment, controller 324 determines during a first period of time that a control point CPx is to transition from being the current control point to being an expired control point—e.g., wherein CPx is now older than a first execution point identified by signal 321. Controller 324 further determines based on the identified first execution point that another control point CPy is to transition from being a pending control point to being the next current control point—e.g., wherein CPy is now the oldest control point which is younger than the first execution point. Accordingly, controller 324 detects the expiration of control point CPx, and that control point CPy is instead to be applied at one or more reservation stations (including RS 340) for the scheduling of one or more instructions for serialized execution. In some embodiments, controller 324 indicates the expiration of control point CPx to RS 340 via signal 334—e.g., by identifying control point CPy as being the current serialization control point.

Similarly, during a second period of time after the first period of time, signal 321 identifies to controller 324 a second execution point of sequence 312 (the second execution point after the first execution point). Based on the identified second execution point, controller 324 accesses registry 325 to determine updates (if any) to the respective expiration states of one or more serialization control points. For example, controller 324 determines based on signal 321 that the control point CPy is to transition from being the current control point to being an expired control point—e.g., wherein CPy is older than the second execution point. Furthermore, controller 324 determines based on signal 321 that another control point CPz is to transition from being a pending control point to being the next current control point—e.g., wherein CPz is now the oldest control point which is younger than the second execution point. Accordingly, controller 324 detects the expiration of control point CPy, and that control point CPz is instead to be applied at the one or more reservation stations (including RS 340) for the scheduling of one or more instructions for serialized execution

In one such embodiment, RS 340 comprises a queue 342 and a scheduler circuit 344 which (for example) provide respective functionality of queue 142 and scheduler circuit 144. Scheduler circuit 344 includes, or otherwise operates with, an evaluation unit 346 (or other suitable circuitry) which is to perform an evaluation, based on queue 342 and signal 334, to determine whether a given instruction is qualified to be released for execution. For example, evaluation unit 346 determines, for a given one such instruction, whether the instruction is older than a current control point, as indicated by signal 334.

In various embodiments, queue 342 comprises entries which each correspond to a different respective instruction of sequence 312 (e.g., a different respective one of the instructions 132a which are provided to RS 140a). In the example embodiment shown, a given one such entry of queue 342 comprises a field 347 which is to provide an instruction identifier (UID)—e.g., wherein field 347 includes or otherwise identifies of the instruction to which the entry in question corresponds. Furthermore, such an entry of queue 342 comprises a field 348 to specify or otherwise indicate an age of the instruction identified in field 347. Further still, such an entry of queue 342 comprises a field 349 to provide an identifier of an executability state(ES) of the instruction identified in field 347.

In an embodiment, evaluation unit 346 performs a comparison of the age of the current control point (which is identified by signal 334) with the age identified in the respective field 348 of a given entry in queue 342. Where the age identified in said field 348 is determined to be older than the current control point, the respective field 349 of that same entry in queue 342 is updated (if necessary) to indicate that the instruction, to which the entry in question corresponds, is now qualified to be released for execution scheduling by scheduler circuit 344.

Accordingly, some embodiments variously enable the enforcement of a control point against a given instruction to take place relatively close—e.g., as compared to enforcement at an allocation unit (for example)—to circuitry which is to schedule execution of that given instruction. Additionally or alternatively, some embodiment variously enable the same control point to be variously enforced are different reservation stations against respective instructions that have been allocated to said different reservation stations.

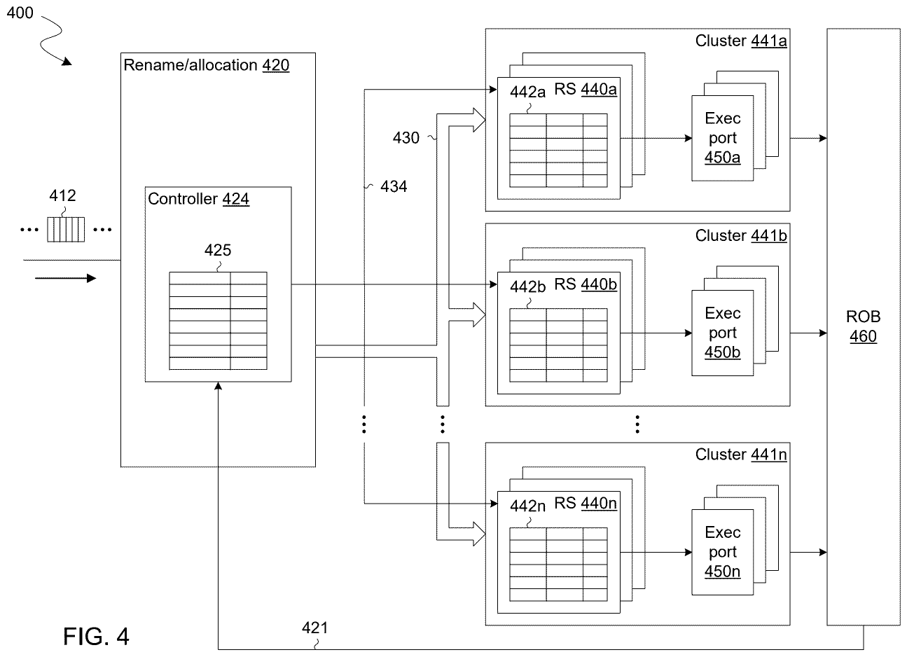

FIG. 4 shows a processor 400 that enforces a serialization control point at each of multiple clusters according to an embodiment. The processor 400 illustrates features of one example embodiment wherein multiple reservation stations, some at different respective clusters of a processor, each enforce a respective one or more serialization control points based on the same indication of a reference control point. In some embodiments, processor 400 provides functionality such as that of processor 110 or processor 300—e.g., wherein operations of method 200 are performed with some or all of processor 400.

In some embodiments, circuitry of processor 400 is adapted from, and/or is incorporated with, any of various suitable processor architectures. By way of illustration and not limitation, any of various suitable embodiments of processor 400 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

As shown in FIG. 4, processor 400 comprises a rename/allocation unit 420, and clusters 441 of processing resources which are variously coupled to rename/allocation unit 420 via a network 430. In an embodiment, rename/allocation unit 420 is coupled to receive a sequence 412 of instructions, and to variously allocate different ones of such instructions each to a respective one of clusters 441—e.g., wherein rename/allocation unit 420 and sequence 412 correspond functionally to allocation unit 120 and sequence 112. In the example embodiment shown, processor 400 comprises clusters 441a, 441b, . . . 441n, wherein each such cluster comprises a respective one or more reservation stations and a respective one or more execution ports which are variously coupled to the one or more reservation stations.

By way of illustration and not limitation, cluster 441a comprises an execution port 450a and a RS 440a which is coupled to release instructions to execution port 450a for subsequent execution by pipeline circuitry (not shown) of cluster 441a. Furthermore, cluster 441b comprises an execution port 450b and a RS 440b which is coupled to release instructions to execution port 450b for subsequent execution at cluster 441b. Further still, cluster 441n comprises an execution port 450n and a RS 440n which is coupled to release instructions to execution port 450n for subsequent execution at cluster 441n.

In an embodiment, a controller 424 of rename/allocation unit 420 includes or otherwise operates based on a registry 425—e.g., wherein controller 424 and registry 425 correspond functionally to controller 324 and registry 325 (respectively). Controller 424 is coupled to receive an identifier of a detected execution point of sequence 412—e.g., wherein the identifier is generated with a reorder buffer (ROB) 460 and communicated to controller 424 via a signal 421. Based on the execution point identified by signal 421, controller 424 maintains registry 425 to track which serialization control point (if any) is a current control point to be used as a basis on which multiple ones of RSs 440a, 440b, . . . , 440n variously schedule respective instructions of sequence 412 for execution.

For example, controller 424 communicates to clusters 441a, 442b, . . . , 441n a signal 434 based on information in registry 425, wherein signal 434 specifies or otherwise indicates a current serialization control point (e.g., thus indicating an expiration of a previous control point). In the example embodiment shown, RSs 440a, 440b, . . . , 440n comprise respective queue 442a, 442b, . . . , 442n which (for example) variously provide functionality such as that of queue 342. Based on the indication of a current control point by signal 434, evaluation circuitry of RS 440a accesses queue 442a to determine whether a given first instruction of sequence 412 is qualified to be released to execution port 450a for subsequent execution at cluster 441a. Furthermore, based on the indication of the same current control point by signal 434, evaluation circuitry of RS 440b accesses queue 442b to determine whether a given second instruction of sequence 412 is qualified to be released to execution port 450b for subsequent execution at cluster 441b. Furthermore, based on the indication of the same current control point by signal 434, evaluation circuitry of RS 440n accesses queue 442n to determine whether a given third instruction of sequence 412 is qualified to be released to execution port 450n for subsequent execution at cluster 441n.

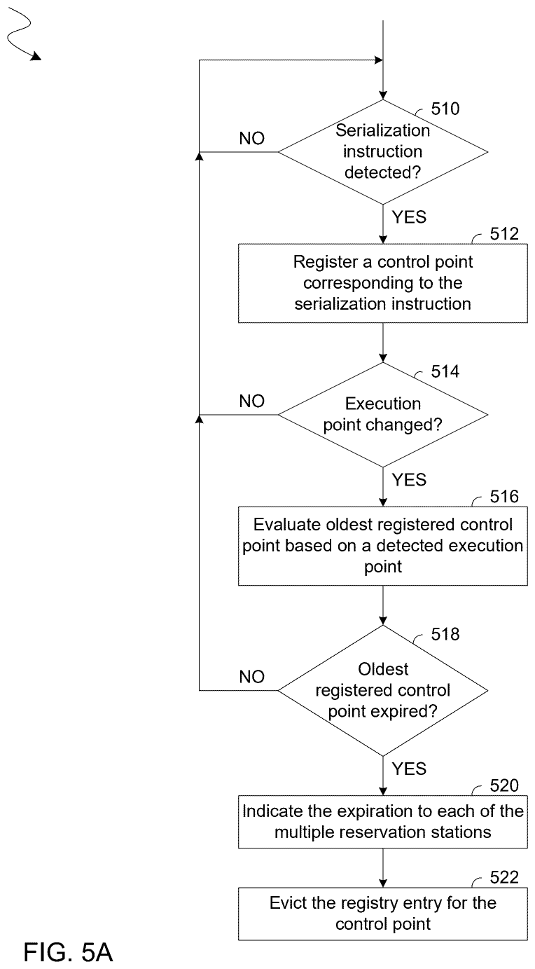

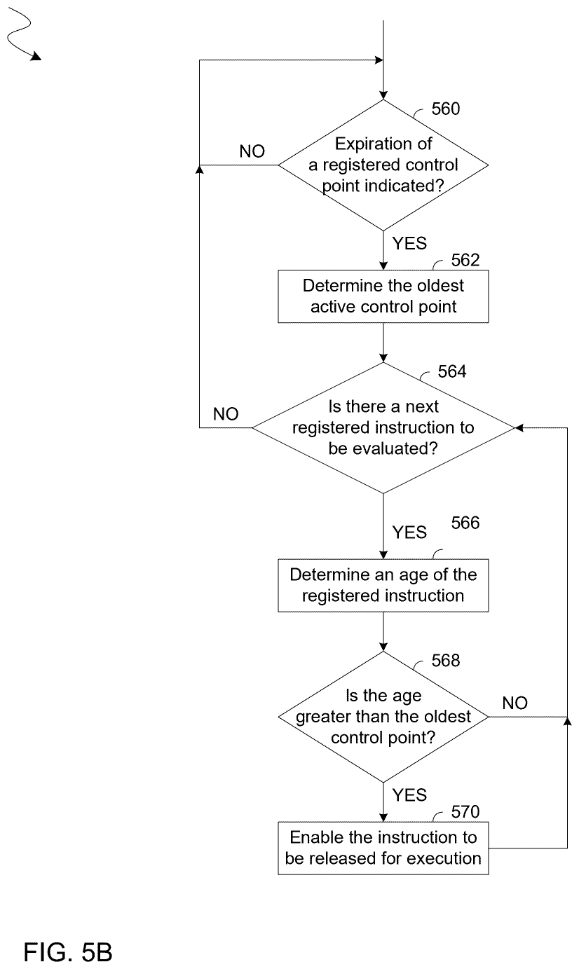

FIG. 5A shows a method 500 for identifying a most recently expired serialization control point according to an embodiment. Operations such as those of method 500 are performed with any of various combinations of suitable hardware (e.g., circuitry), firmware and/or executing software which, for example, provide some or all of the functionality of processor 110 or processor 300—e.g., wherein operations of method 200 include, or are otherwise based on, method 500. As shown in FIG. 5A, method 500 comprises performing an evaluation (at 510) to detect for the presence of a new serialization instruction—i.e., one not previously processed by method 500—in an instruction sequence. Where it is determined at 510 that no new serialization instruction is detected, method 500 performs a next instance of the evaluating at 510—e.g., until a next new serialization instruction is detected. Where the evaluating at 510 instead detects a new serialization instruction, method 500 (at 512) registers both a control point which corresponds to detected serialization instruction.

Method 500 further comprises performing an evaluation (at 514) to determine whether a detected point of execution of the instruction sequence (for example, the youngest execution point detected to-date) has changed—e.g., since a preceding evaluation at 514 (if any). Where it is determined at 514 that the execution point has yet to change since the preceding evaluation at 514, method 500 performs a next instance of the evaluating at 510. Where it is instead determined at 514 that the execution point has changed, method 500 (at 516) evaluates the oldest currently registered (e.g., not yet deleted, invalidated, or otherwise mooted) control point based on the detected execution point—e.g., to determine whether execution has passed said oldest currently registered control point.

Based on the evaluation at 516, method 500 determines (at 518) whether the control point most recently evaluated at 516 has expired. Where it is determined at 518 that the evaluated control point has not yet expired, method 500 performs a next instance of the evaluating at 510. Where it is instead determined at 518 that the evaluated control point has expired, method 500 (at 520) specifies or otherwise indicates the expiration to each of multiple reservation stations of the processor, and (at 522) evicts the expired control point from an entry of the registry.

FIG. 5B shows a method 550 for identifying executable instructions at a reservation station according to an embodiment. Operations such as those of method 550 are performed with any of various combinations of suitable hardware, firmware and/or executing software which, for example, provide some or all of the functionality of processor 110 or processor 300—e.g., wherein operations of method 200 and/or method 500 include, or are otherwise based on, method 500.

As shown in FIG. 5B, method 550 comprises performing an evaluation (at 560) to determine whether a registered control point has expired. In one such embodiment, the evaluating at 560 is to detect whether a signal (such as one of signals 134, 334, 434) has changed to indicate a different control point as being the oldest currently registered control point. Where the evaluation at 560 fails to detect the expiration of any registered control point, method 500 performs a next instance of the evaluating at 560 - e.g., until a next control point expiration is detected.

Where the evaluating at 560 instead detects the expiration of a registered control point, method 500 (at 562) determines the oldest control point which is currently active (i.e., which is not yet deleted, invalidated, or the like). Method 550 subsequently performs another evaluation (at 564) to determine whether there is any next registered instruction (e.g., registered at one of the queues 142, 342, 442) to be evaluated based on the control point most recently determined at 562. Where the evaluating at 564 fails to identify a next registered instruction to be evaluated, method 550 performs a next instance of the evaluating at 560.

Where the evaluating at 564 instead identifies a next registered instruction to be evaluated, method 500 (at 566) determines an age of the registered instruction which is most recently identified at 564. Method 550 subsequently performs another evaluation (at 568) to determine whether the age most recently identified at 566 is greater than the oldest currently active control point, as most recently identified at 562. Where it is determined at 568 that the identified age is not greater than the oldest currently active control point, method 550 performs a next instance of the evaluating at 564. Otherwise, method 550 (at 570) enables the instruction, which has the age most recently identified at 566, to be released for execution. In an embodiment, method 550 performs the next instance of the evaluating at 564 after the enabling at 570.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors'local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures-in-Order and Out-of-Order Core Block Diagram

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry

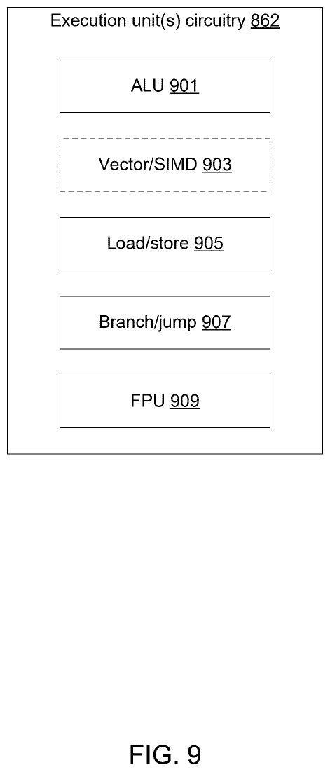

FIG. 9 illustrates examples of execution unit(s) circuitry, such as execution unit(s) circuitry 862 of FIG. 8B. As illustrated, execution unit(s) circuity 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

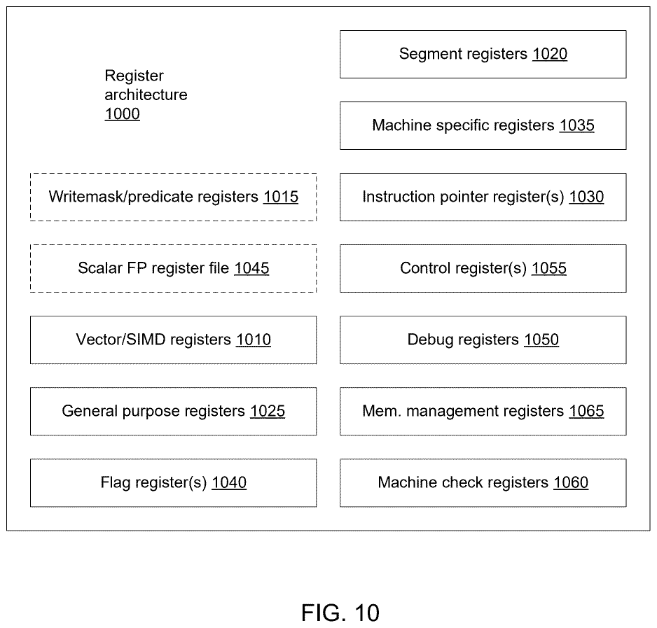

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64- bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

Techniques and architectures for scheduling execution of microoperations are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, a processor comprises first circuitry to allocate multiple instructions, of a sequence of instructions, each to a different respective one of multiple reservation stations, the first circuitry further to identify a serialization control point based on the sequence of instructions, to receive an indication of a detected execution point of the sequence, and to detect an expiration of the serialization control point based on the detected execution point, and a first reservation station of the multiple reservation stations, the first reservation station coupled to receive a first instruction of the sequence, and to receive from the first circuitry an indication of the expiration, the first reservation station comprising a first queue to register first serialization information which corresponds to the first instruction, the first serialization information to indicate a first age of the first instruction, and second circuitry coupled to the first queue, the second circuitry to schedule an execution of the first instruction, comprising the second circuitry to signal, based on the indication of the current serialization control point and the first serialization information, that the first instruction is qualified to be released to a respective execution port.

In one or more second embodiments, further to the first embodiment, a second reservation station of the multiple reservation stations is coupled to receive a second instruction of the sequence, and is further coupled to receive from the first circuitry the indication of the expiration, and the second reservation station comprises a second queue to register second serialization information which corresponds to the second instruction, the second serialization information to indicate a second age of the second instruction, and third circuitry coupled to the second queue, the third circuitry to schedule an execution of the second instruction, comprising the third circuitry to signal, based on the indication of the current serialization control point and the second serialization information, that the second instruction is qualified to be released to a respective execution port.

In one or more third embodiments, further to the second embodiment, the first queue is dedicated to a first one or more instruction types, and the second queue is dedicated to a second one or more instruction types other than any of the first one or more instruction types.

In one or more fourth embodiments, further to the first embodiment or the second embodiment, a first cluster of the processor comprises the first reservation station and the second reservation station.

In one or more fifth embodiments, further to the first embodiment or the second embodiment, a first cluster of the processor comprises the first reservation station, and a second cluster of the processor comprises the second reservation station.

In one or more sixth embodiments, further to the first embodiment or the second embodiment, the serialization control point is a first serialization control point, the first circuitry is to identify multiple serialization control points based on the sequence of instructions, and the first circuitry to detect the expiration comprises the first circuitry to determine that, of the multiple serialization control points, the first serialization control point is a closest serialization control point prior to the detected execution point.

In one or more seventh embodiments, further to the sixth embodiment, the first circuitry is further to maintain a queue of serialization control points.

In one or more eighth embodiments, further to the first embodiment or the second embodiment, the first reservation station corresponds to a reorder buffer of the processor, wherein the reorder buffer is to provide an identifier of an instruction, the indication of the detected execution point is to be based on the identifier of the instruction.

In one or more ninth embodiments, further to the first embodiment or the second embodiment, the serialization control point is to be set by a serialization instruction of the sequence, the first circuitry is to release the serialization control point prior to a retirement of the serialization instruction.

In one or more tenth embodiments, a method at a processor comprises allocating multiple instructions, of a sequence of instructions, each to a different respective one of multiple reservation stations, identifying a serialization control point based on the sequence of instructions, receiving an indication of a detected execution point of the sequence, and detecting an expiration of the serialization control point based on the detected execution point, at a first reservation station of the multiple reservation stations receiving a first instruction of the sequence receiving an indication of the expiration, with a first queue of the first reservation station, registering first serialization information which corresponds to the first instruction, wherein the first serialization information indicates a first age of the first instruction, and scheduling an execution of the first instruction, comprising signaling, based on the indication of the current serialization control point and the first serialization information, that the first instruction is qualified to be released to a respective execution port.

In one or more eleventh embodiments, further to the tenth embodiment, the method further comprises at a second reservation station of the multiple reservation stations receiving a second instruction of the sequence receiving the indication of the expiration, with a second queue of the second reservation station, registering second serialization information which corresponds to the second instruction, wherein the second serialization information indicates a second age of the second instruction, and scheduling an execution of the second instruction, comprising signaling, based on the indication of the current serialization control point and the second serialization information, that the second instruction is qualified to be released to a respective execution port.

In one or more twelfth embodiments, further to the eleventh embodiment, the first queue is dedicated to a first one or more instruction types, and the second queue is dedicated to a second one or more instruction types other than any of the first one or more instruction types.

In one or more thirteenth embodiments, further to the tenth embodiment or the eleventh embodiment, a first cluster of the processor comprises the first reservation station and the second reservation station.

In one or more fourteenth embodiments, further to the tenth embodiment or the eleventh embodiment, a first cluster of the processor comprises the first reservation station, and a second cluster of the processor comprises the second reservation station.

In one or more fifteenth embodiments, further to the tenth embodiment or the eleventh embodiment, the serialization control point is a first serialization control point of multiple serialization control points identified based on the sequence of instructions, detecting the expiration comprises determining that, of the multiple serialization control points, the first serialization control point is a closest serialization control point prior to the detected execution point.

In one or more sixteenth embodiments, further to the fifteenth embodiment, the method further comprises maintaining a queue of serialization control points, and generating the indication of the expiration based on the queue of serialization control points.

In one or more seventeenth embodiments, further to the tenth embodiment or the eleventh embodiment, the first reservation station corresponds to a reorder buffer of the processor, wherein the reorder buffer is to provide an identifier of an instruction, the indication of the detected execution point is based on the identifier of the instruction.

In one or more eighteenth embodiments, further to the tenth embodiment or the eleventh embodiment, the serialization control point is set by a serialization instruction of the sequence, the method further comprises releasing the serialization control point prior to a retirement of the serialization instruction.

In one or more nineteenth embodiments, a system comprises a memory, a memory controller, and a processor coupled to the memory via the memory controller, the processor comprising first circuitry to allocate multiple instructions, of a sequence of instructions, each to a different respective one of multiple reservation stations, the first circuitry further to identify a serialization control point based on the sequence of instructions, to receive an indication of a detected execution point of the sequence, and to detect an expiration of the serialization control point based on the detected execution point, and a first reservation station of the multiple reservation stations, the first reservation station coupled to receive a first instruction of the sequence, and to receive from the first circuitry an indication of the expiration, the first reservation station comprising a first queue to register first serialization information which corresponds to the first instruction, the first serialization information to indicate a first age of the first instruction, and second circuitry coupled to the first queue, the second circuitry to schedule an execution of the first instruction, comprising the second circuitry to signal, based on the indication of the current serialization control point and the first serialization information, that the first instruction is qualified to be released to a respective execution port.

In one or more twentieth embodiments, further to the nineteenth embodiment, a second reservation station of the multiple reservation stations is coupled to receive a second instruction of the sequence, and is further coupled to receive from the first circuitry the indication of the expiration, and the second reservation station comprises a second queue to register second serialization information which corresponds to the second instruction, the second serialization information to indicate a second age of the second instruction, and third circuitry coupled to the second queue, the third circuitry to schedule an execution of the second instruction, comprising the third circuitry to signal, based on the indication of the current serialization control point and the second serialization information, that the second instruction is qualified to be released to a respective execution port.

In one or more twenty-first embodiments, further to the twentieth embodiment, the first queue is dedicated to a first one or more instruction types, and the second queue is dedicated to a second one or more instruction types other than any of the first one or more instruction types.

In one or more twenty-second embodiments, further to the nineteenth embodiment or the twentieth embodiment, a first cluster of the processor comprises the first reservation station and the second reservation station.

In one or more twenty-third embodiments, further to the nineteenth embodiment or the twentieth embodiment, a first cluster of the processor comprises the first reservation station, and a second cluster of the processor comprises the second reservation station.

In one or more twenty-fourth embodiments, further to the nineteenth embodiment or the twentieth embodiment, the serialization control point is a first serialization control point, the first circuitry is to identify multiple serialization control points based on the sequence of instructions, and the first circuitry to detect the expiration comprises the first circuitry to determine that, of the multiple serialization control points, the first serialization control point is a closest serialization control point prior to the detected execution point.

In one or more twenty-fifth embodiments, further to the twenty-fourth embodiment, the first circuitry is further to maintain a queue of serialization control points.

In one or more twenty-sixth embodiments, further to the nineteenth embodiment or the twentieth embodiment, the first reservation station corresponds to a reorder buffer of the processor, wherein the reorder buffer is to provide an identifier of an instruction, the indication of the detected execution point is to be based on the identifier of the instruction.

In one or more twenty-seventh embodiments, further to the nineteenth embodiment or the twentieth embodiment, the serialization control point is to be set by a serialization instruction of the sequence, the first circuitry is to release the serialization control point prior to a retirement of the serialization instruction.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A processor comprising:
first circuitry to allocate multiple instructions, of a sequence of instructions, each to a different respective one of multiple reservation stations, the first circuitry further to identify a serialization control point based on the sequence of instructions, to receive an indication of a detected execution point of the sequence, and to detect an expiration of the serialization control point based on the detected execution point; and
a first reservation station of the multiple reservation stations, the first reservation station coupled to receive a first instruction of the sequence, and to receive from the first circuitry an indication of the expiration, the first reservation station comprising:
a first queue to register first serialization information which corresponds to the first instruction, the first serialization information to indicate a first age of the first instruction; and
second circuitry coupled to the first queue, the second circuitry to schedule an execution of the first instruction, comprising the second circuitry to signal, based on the indication of the current serialization control point and the first serialization information, that the first instruction is qualified to be released to a respective execution port.

2. The processor of claim 1, wherein:
a second reservation station of the multiple reservation stations is coupled to receive a second instruction of the sequence, and is further coupled to receive from the first circuitry the indication of the expiration; and
the second reservation station comprises:
a second queue to register second serialization information which corresponds to the second instruction, the second serialization information to indicate a second age of the second instruction; and
third circuitry coupled to the second queue, the third circuitry to schedule an execution of the second instruction, comprising the third circuitry to signal, based on the indication of the current serialization control point and the second serialization information, that the second instruction is qualified to be released to a respective execution port.

3. The processor of claim 2, wherein:
the first queue is dedicated to a first one or more instruction types; and
the second queue is dedicated to a second one or more instruction types other than any of the first one or more instruction types.

4. The processor of claim 1, wherein a first cluster of the processor comprises the first reservation station and the second reservation station.

5. The processor of claim 1, wherein:
a first cluster of the processor comprises the first reservation station; and
a second cluster of the processor comprises the second reservation station.

6. The processor of claim 1, wherein:
the serialization control point is a first serialization control point;
the first circuitry is to identify multiple serialization control points based on the sequence of instructions; and
the first circuitry to detect the expiration comprises the first circuitry to determine that, of the multiple serialization control points, the first serialization control point is a closest serialization control point prior to the detected execution point.

7. The processor of claim 6, wherein the first circuitry is further to maintain a queue of serialization control points.

8. The processor of claim 1, wherein:
the first reservation station corresponds to a reorder buffer of the processor, wherein the reorder buffer is to provide an identifier of an instruction;
the indication of the detected execution point is to be based on the identifier of the instruction.

9. The processor of claim 1, wherein:
the serialization control point is to be set by a serialization instruction of the sequence;
the first circuitry is to release the serialization control point prior to a retirement of the serialization instruction.

10. A method at a processor, the method comprising:
allocating multiple instructions, of a sequence of instructions, each to a different respective one of multiple reservation stations;
identifying a serialization control point based on the sequence of instructions;
receiving an indication of a detected execution point of the sequence; and
detecting an expiration of the serialization control point based on the detected execution point;
at a first reservation station of the multiple reservation stations:
receiving a first instruction of the sequence
receiving an indication of the expiration;
with a first queue of the first reservation station, registering first serialization information which corresponds to the first instruction, wherein the first serialization information indicates a first age of the first instruction; and
scheduling an execution of the first instruction, comprising signaling, based on the indication of the current serialization control point and the first serialization information, that the first instruction is qualified to be released to a respective execution port.

11. The method of claim 10, further comprising:
at a second reservation station of the multiple reservation stations:
receiving a second instruction of the sequence
receiving the indication of the expiration;
with a second queue of the second reservation station, registering second serialization information which corresponds to the second instruction, wherein the second serialization information indicates a second age of the second instruction; and
scheduling an execution of the second instruction, comprising signaling, based on the indication of the current serialization control point and the second serialization information, that the second instruction is qualified to be released to a respective execution port.

12. The method of claim 10, wherein:
a first cluster of the processor comprises the first reservation station; and
a second cluster of the processor comprises the second reservation station.

13. The method of claim 10, wherein:
the serialization control point is a first serialization control point of multiple serialization control points identified based on the sequence of instructions;
detecting the expiration comprises determining that, of the multiple serialization control points, the first serialization control point is a closest serialization control point prior to the detected execution point.

14. The method of claim 13, further comprising:
maintaining a queue of serialization control points; and
generating the indication of the expiration based on the queue of serialization control points.

15. The method of claim 10, wherein:
the first reservation station corresponds to a reorder buffer of the processor, wherein the reorder buffer is to provide an identifier of an instruction;
the indication of the detected execution point is based on the identifier of the instruction.

16. A system comprising:
a memory;
a memory controller; and
a processor coupled to the memory via the memory controller, the processor comprising:
first circuitry to allocate multiple instructions, of a sequence of instructions, each to a different respective one of multiple reservation stations, the first circuitry further to identify a serialization control point based on the sequence of instructions, to receive an indication of a detected execution point of the sequence, and to detect an expiration of the serialization control point based on the detected execution point; and
a first reservation station of the multiple reservation stations, the first reservation station coupled to receive a first instruction of the sequence, and to receive from the first circuitry an indication of the expiration, the first reservation station comprising:
a first queue to register first serialization information which corresponds to the first instruction, the first serialization information to indicate a first age of the first instruction; and
second circuitry coupled to the first queue, the second circuitry to schedule an execution of the first instruction, comprising the second circuitry to signal, based on the indication of the current serialization control point and the first serialization information, that the first instruction is qualified to be released to a respective execution port.

17. The system of claim 16, wherein:
a second reservation station of the multiple reservation stations is coupled to receive a second instruction of the sequence, and is further coupled to receive from the first circuitry the indication of the expiration; and
the second reservation station comprises:
a second queue to register second serialization information which corresponds to the second instruction, the second serialization information to indicate a second age of the second instruction; and
third circuitry coupled to the second queue, the third circuitry to schedule an execution of the second instruction, comprising the third circuitry to signal, based on the indication of the current serialization control point and the second serialization information, that the second instruction is qualified to be released to a respective execution port.

18. The system of claim 16, wherein:
a first cluster of the processor comprises the first reservation station; and
a second cluster of the processor comprises the second reservation station.

19. The system of claim 16, wherein:
the serialization control point is a first serialization control point;
the first circuitry is to identify multiple serialization control points based on the sequence of instructions; and
the first circuitry to detect the expiration comprises the first circuitry to determine that, of the multiple serialization control points, the first serialization control point is a closest serialization control point prior to the detected execution point.

20. The system of claim 19, wherein the first circuitry is further to maintain a queue of serialization control points.
